(19) United States
(12) Patent Application Publication
(10) Pub. No.: US 2006/0026326 A1
(43) Pub. Date: Feb. 2, 2006

(54) Docking station that can perform an activity without a portable electronics device mated thereto

(76) Inventors: Peter D. Hunt, Magnolia, TX (US); Frederick L. Lathrop, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/903,390

(22) Filed: Jul. 30, 2004

(51) Int. Cl. G06F 13/00

(52) U.S. Cl. 710/303

(57) ABSTRACT

A docking station comprises control logic adapted to mate with a portable electronics device to provide the portable electronics device with access to a network. The control logic is able to cause a user-selected activity to be performed by the docking station while a portable electronics device is not mated with the docking station. In another embodiment, a system comprises a docking station to which a portable electronics device is adapted to dock. The docking station contains a central processing unit (“CPU”), an operational device and a remote control interface. The docking station is configured so that regardless of whether the portable electronics device is docked to the docking station, the operational device can be controlled via signals received by the remote control interface from a remote control.

### BACKGROUND

A docking station generally couples various peripheral devices and ports contained in the docking station to a notebook computer. Examples of such peripheral devices include a display and storage units (e.g., hard drive and optical disk drive). The ports may include a network port by which the notebook computer can access a network. By docking the notebook computer to the docking station, a user can use the notebook's microprocessor and software in conjunction with peripheral devices and ports associated with the docking station. For example, the user can either use the notebook's built-in display or a separate, possibly larger, display coupled to the docking station. Despite the presence of various peripheral devices and ports in the docking station, the docking station is relatively useless without a notebook docked thereto.

### BRIEF SUMMARY

In accordance with at least some embodiments, a docking station comprises control logic adapted to mate with a portable electronics device to provide the portable electronics device with access to a network. The control logic is able to cause a user-selected activity to be performed by the docking station while a portable electronics device is not mated with the docking station.

In accordance with another embodiment, a system comprises a docking station to which a portable electronics device is adapted to dock. The docking station contains a central processing unit (“CPU”), an operational device and a remote control interface. The docking station is configured so that regardless of whether the portable electronics device is docked to the docking station, the operational device can be controlled via signals received by the remote control interface from a remote control. Various associated methods are also disclosed herein.

### BRIEF DESCRIPTION OF THE DRAWINGS

For a detailed description of exemplary embodiments of the invention, reference will now be made to the accompanying drawings in which:

FIG. 1 shows an embodiment in which a portable electronics device may couple to a docking station and the docking station can perform work without the presence of the portable electronics device;

FIG. 2 shows an embodiment in which the portable electronics device comprises a portable computer and the docking station able to perform one or more activities (e.g., video recording) even in the absence of the portable computer;

FIG. 3 shows a method embodiment for initializing a docking station;

FIG. 4 shows a method embodiment for configuring the operation of a docking station using a portable computer; and

FIG. 5 shows a method embodiment associated with docking a portable computer to a docking station while the docking station is performing an activity.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

The term “portable electronics device” is used herein to refer to any type of portable, docking station-compliant electronics device. An example includes a portable computer.

### DETAILED DESCRIPTION

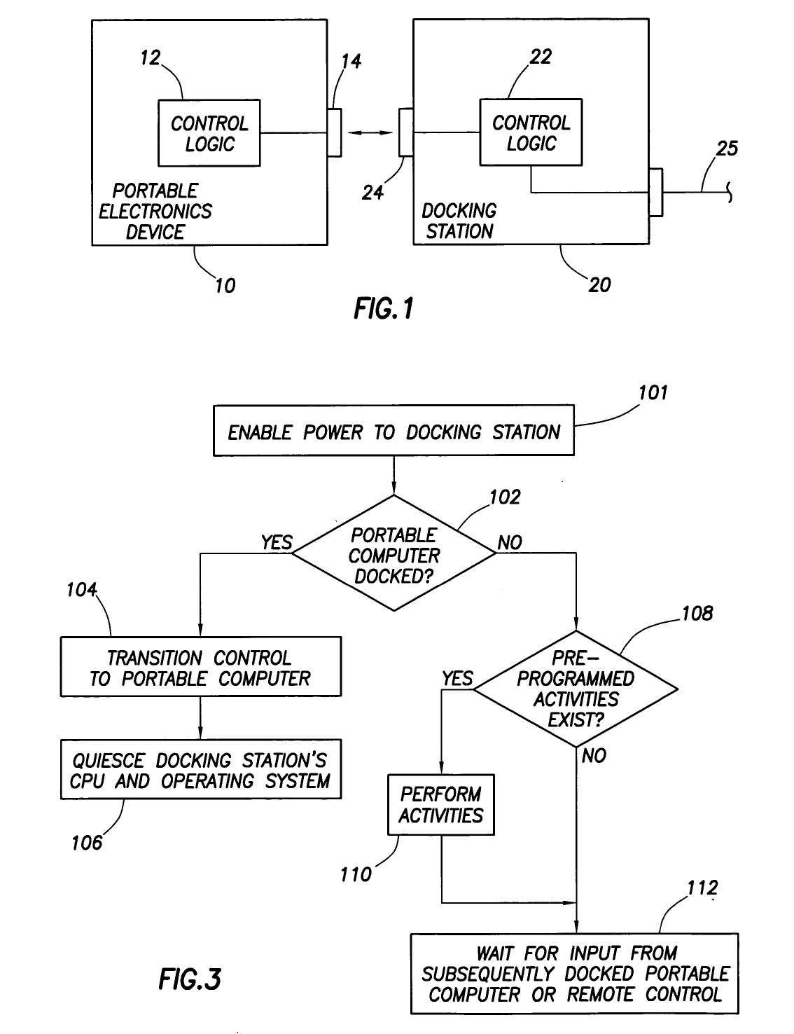

FIG. 1 shows an exemplary embodiment of the invention in which a portable electronics device 10 may or may not be mated with a docking station 20. Connectors 14 and 24 are provided on the portable electronics device 10 and docking station 20 as shown to permit the devices to be mated when desired. The portable electronics device 10 comprises control logic 12. The portable electronics device 10 may be representative of a wide variety of devices. Examples of a portable electronics device 10 include portable computers (including notebook computers and handheld computers) and personal data assistants. The operation of the portable electronics device 10 is generally dictated by the operation of the control logic 12 which may comprise a central processing unit (“CPU”), memory, and other components. The docking station 20 comprises control logic 22. The operation of the docking station 20 is generally dictated by the operation of the control logic 22 which also may comprise a CPU, memory, and other components.

As noted above, the portable electronics device 10 is able to be mated to the docking station 20. When mated together, the docking station 20 provides access to a network connection 25 on behalf of the portable electronics device 10. However, the portable electronics device 10 need not be mated to the docking station 20. When not mated, the portable electronics device 10 may perform various activities as permitted by the control logic 12. If the portable electronics device 10 comprises a portable computer, such activities may include word processing, spreadsheet management, and other activities typical of portable computers. In accordance with exemplary embodiments of the invention, the docking station 20 also may perform various activities as permitted by the docking station's control logic 22 when the portable electronics device is not mated thereto. As such, the docking station 20 may perform useful work apart from the portable electronics device 10.

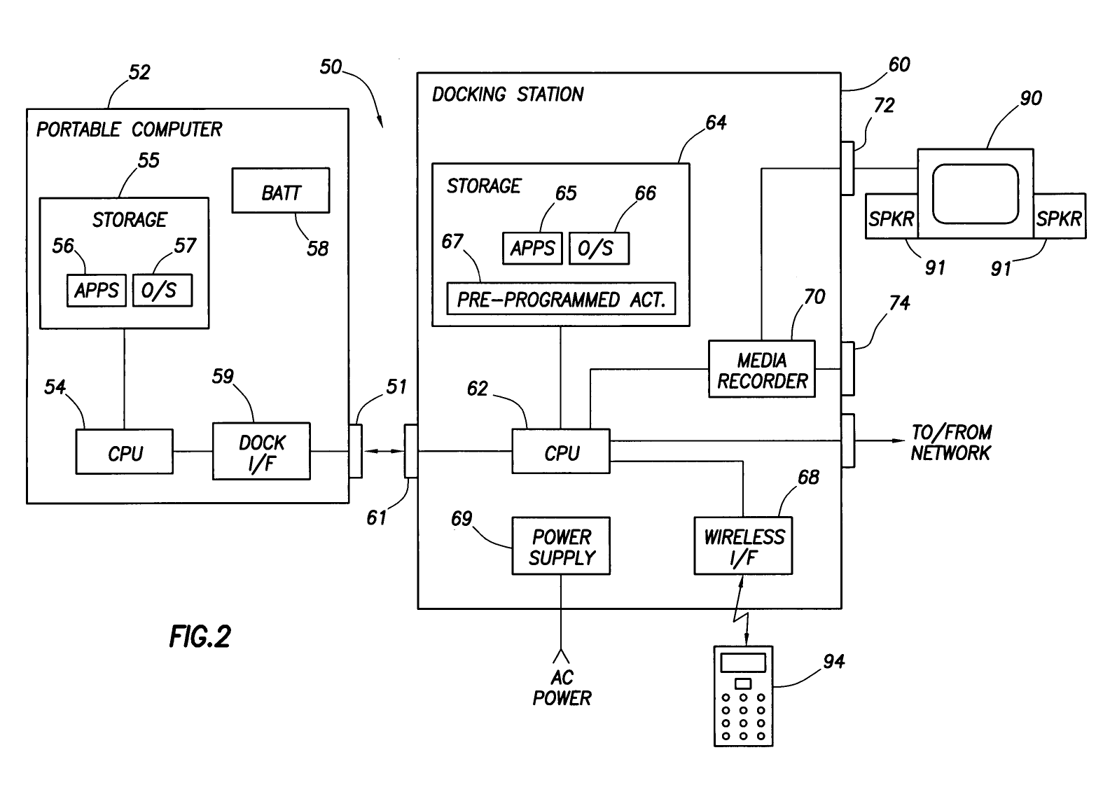

FIG. 2 shows an exemplary implementation of the system of FIG. 1. In FIG. 2, a system 50 comprises a portable computer 52 and a docking station 60. When desired, a user may dock the portable computer 52 to the docking station 60. The portable computer 52 includes a connector 51 and docking station 60 includes a corresponding connector 61. Docking the portable computer 52 to the docking station 60 includes causing the connectors 51 and 61 to mate with each other. Examples of a dockable portable computer and docking station are provided in U.S. Pat. Nos. 6,683,786; 6,583,984, and 6,567,876, all of which are incorporated herein by reference.

In general, the portable computer 52 comprises a CPU 54 coupled to storage 55 and a dock interface 59. The CPU 54 executes the applications 56 running in concert with operating system 57. The applications may comprise any desired applications such as word processing applications, web browsers, or database management applications. A battery 58 may be included as well to provide power for the portable computer 52. The battery 58 may provide power for the portable computer when the computer is not docked or when docked to the extent that the docking station 60 does not or cannot provide power to the portable computer. Other components (not specifically shown) may also be included as part of the portable computer 52.

The docking station 60 comprises a CPU 62, storage 64, a wireless interface 68, a power supply 69, a media recorder 70 and various ports 72, 74, 76, 78, 80, and 82. The storage 64 may comprise random access memory, read only memory, a hard disk drive, an optical drive, flash memory and/or other forms of storage. Storage 64 may comprise one or more applications 65 and an operating system 66. The CPU 62 executes the applications 65 under the operating system 66. The operating system 66 may be the same or different than the operating system 57 in the portable computer 52.

The power supply 69 receives alternating current (“AC”) power from an external source (e.g., a wall plug) and converts that power to one or more suitable DC voltages for use by the various components in the docking station 60. Further, power may be provided by the power supply 60 through connectors 61 and 51 and to the portable computer 52 when docked.

In general, exemplary embodiments of the invention enable the control logic (e.g., CPU) in the docking station 60 to cause a user-selected activity to be performed without having a portable electronics device mated with the docking station. The media recorder 70 is an example of an operational device that performs useful work associated with the docking station 60 even if no portable computer 52 is docked to the docking station. The media recorder 70 receives a video source signal via port 74. The media recorder 70 comprises video interface circuitry and storage to permit incoming video to be digitized and stored. The media recorder 70 is communicatively coupled to the CPU 62 or other control logic. Such digitized video can be played back through port 72 which can be connected to a display monitor 90 (e.g., a television or computer monitor). In addition to or instead of video, the docking station can also record an audio source signal and play back the audio through speakers 91 associated with the display monitor 90. Suitable implementations of media recorders 70 can be found in U.S. Pat. Pub. Nos. 2003/0053798 and 2004/0078829, both of which are incorporated herein by reference. The terms “audio source signal” and “video source signal” refer to the incoming audio and/or video information regardless of format or encoding. For example, the signals may comprise analog signals, digitals, Moving Picture Experts Group-2 (“MPEG-2”) encoded bitstreams, or any other suitable type of media signals.

The wireless interface 68 permits the docking station 60 to communicate with a wireless remote control device 94 and thus to receive control signals from the remote control device 94. Wireless remote control device 94 may be implemented as a radio frequency or infrared remote control that can be used to control the operation of the media recorder 70. Via the wireless control device 94, an operational device (e.g., the media recorder 70) within the docking station is controlled via signals received by the wireless interface 68 regardless of whether the personal electronics device 52 is docked to the docking station. For example, a user can start and stop playback of video, control video recording (e.g., start and stop times, channel), control volume and control other video and/or audio-related actions.

When docked, the portable computer 52, under control of applications 55 and operating system 57, is capable of controlling the media recorder 70. Via the portable computer 52, a user can program the start and stop times for recording by the media recorder 70 as well as program the channel to be recorded. Further, using the portable computer 52, a user can generate and have stored in the storage 64 of the docking station 60 one or more pre-programmed activities 67. Also, the wireless control device 94 can be used to program the activities into the docking station. The pre-programmed activities 67 may be stored in storage in a file or other suitable storage format 65. Such activities can be executed by the docking station 60 at a time when no portable computer 52 is docked to, or otherwise in control of, the docking station or when the portable computer 52 is docked. For example, a user programs the docking station to record a particular television broadcast a certain time and on a certain channel. Prior to the programmed time, the user for whatever reason undocks the portable computer 52 from the docking station 60. At the programmed time, the docking station 60, under control of its own CPU 62 and operating system 66, causes the media recorder 70 to record the desired television broadcast for the user. Any other user-controllable features that the media recorder 70 provides can also be controlled by a user via the portable computer 52. When a portable computer is not docked to the docking station 60, the docking station, under control of application 65 and operating system 66, is capable of controlling the media recorder 70 via the remote control 94 and wireless interface 68.

FIG. 3 shows an exemplary method of initializing a docking station (e.g., the docking station 60 of FIG. 2). The docking station initialization method of FIG. 3 is performed largely or exclusively by the CPU 62 executing the operating system 66. Upon, or after, enabling power to the docking station, in block 102, a determination is made as to whether a portable computer 52 is docked. Numerous techniques are possible for determining whether a computer is docked to a docking station such as that disclosed in U.S. Pat. No. 6,170,020, incorporated herein by reference. If portable computer 50 is docked, then in block 104 control passes to the CPU and operating system of the portable computer. Further, the docking station's operating system 66 and CPU 62 are quiesced (block 106). Quiescing the docking station's operating system and CPU may involve placing the operating system in a non-operational state and/or transitioning the CPU to a low power mode of operation. At this point, the portable computer's operating system and CPU are in control of various of the components of the docking station such as the media recorder 70.

If, however, no portable computer 52 is present at the docking station 60 during initialization of the docking station, then the docking station's CPU 62 determines (block 108) whether any pre-programmed activities exist to be performed. This functionality can be performed by the CPU 62 examining the storage 64 for pre-programmed activities 67. If any pre-programmed activities 67 exist, the CPU 62 performs, or causes to be performed, the activities (block 110) at the scheduled time(s). As noted above, such activities may include causing the media recorder 70 to record a television broadcast at a certain time and on a certain channel. If no pre-programmed activities 67 exist, control passes to block 112 in which the docking station's CPU 62 waits for further input such as may be provided by a subsequently docked portable computer 50 or by the remote control 94. After performing the activities in block 110, control transitions to block 112.

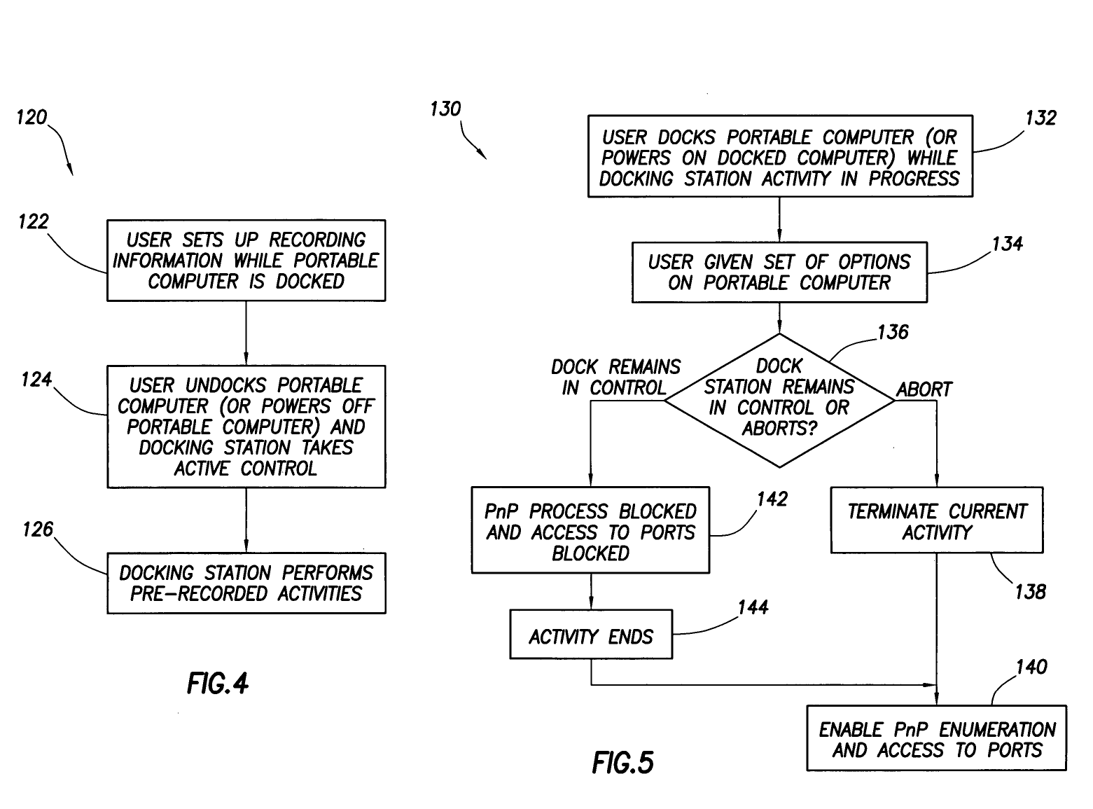

FIG. 4 shows a method 120 for configuring the operation of a the docking station 60 using a portable computer 52. At 122, a user sets up recording information while the portable computer 52 is docked to the docking station. This may be accomplished using a graphical user interface on the portable computer and selecting, for example, a recording start time, recording stop time, and channel and having the recording information stored in the storage 64 of the docking station. Multiple recording sessions may be stored in this manner. Additional or different recording information may be stored as well. At 124, a user may undock the portable computer 52 or power off the portable computer while it is still docked. The docking station 60 detects the removal of the portable computer 52 or cessation of operation of the portable and transitions to an active management role, e.g., by transitioning the docking station's CPU 62 and operating system 66 to an active mode. At 126, the docking station 60 performs one or more of the pre-recorded activities, if any.

FIG. 5 shows a method 130 associated with docking the portable computer 52 to the docking station 60 while the docking station is actively performing an activity, such as might be the case, for example, during block 110 in FIG. 3 or block 126 in FIG. 4. At 132 in FIG. 5, a user docks the portable computer 52 or powers on an already docked portable computer. This may occur while the docking station 60, for example, is actively recording a television broadcast. The docking station 60 detects the presence of the portable computer and, in block 134, via the display monitor 90, the user is provided with one or more selectable options. One option is to permit the docking station 60 to remain in control and continue its activity (e.g., recording). Another option is to abort the activity currently being performed by the docking station. Via a graphical user interface on the display monitor and input from the user via remote control 94, decision block 136 determines the option selected by the user. If the user opts to abort the activity being performed by the docking station 60, at block 138, the docking station's current activity is terminated. If the current activity comprises recording a television broadcast, the recording is ceased. The portable computer 52 may be implemented with Plug-n-Play (“PnP”) capability which, upon detection of the docking station 60, at 140 automatically enumerates whatever devices and ports are present in the docking station. Access by the newly docked portable computer 52 to such devices and ports is permitted. Control thus transitions from the docking station 60 to the portable computer. Yet another option to those shown in FIG. 5 is to permit the docking station to continue its activity while switching control to the portable computer.

If, on the other hand, the user opts at 136 to permit the docking station 60 to remain in control, at block 142, the docking station's CPU 62 and operating system 66 remain in control. This act may comprise blocking all attempts by the portable computer 52 to perform the PnP process described above (e.g., enumeration of devices and ports in the docking station). Eventually, at 144 the activity being performed by the docking station 60 will end of its own accord (e.g., the stop recording time is reached). If desired, the portable computer's PnP process is performed at that time (block 140) to transaction control from the docking station 60 to the portable computer. Alternatively, even upon reaching the end of the docking station's pre-programmed activity 67, it may be desired for control to remain with the docking station 60. Accordingly, the docking station 60 may enter an idle state in which input, such as input by a user of the remote control 94, is awaited to perform another activity.

Detecting a docked portable computer (block 132), providing an interactive set of options to the user on the display monitor 90 and implementing the selection made by the user (docking station remains in control or docking station control aborted) are actions that are performed by the docking station's CPU 62 per the operating system 66. If control by the docking station 60 ends, either by choice of the user at 136 or at the end of the docking station's activity at 144, the docking station's CPU 62 and operating system 66 are quiesced as described above.

The above discussion is meant to be illustrative of the principles and various embodiments of the present invention. Numerous variations and modifications will become apparent to those skilled in the art once the above disclosure is fully appreciated. For example, the order of the blocks shown in FIGS. 3-5 can be different from that shown and one or more of the functions depicted in the blocks may be omitted. Further, some functions can be combined as desired. It is intended that the following claims be interpreted to embrace all such variations and modifications.

What is claimed is:

1. A docking station, comprising:
control logic, adapted to mate with a portable electronics device;
wherein said control logic is able to cause a user-selected activity to be performed by the docking station while a portable electronics device is not mated with the docking station.

2. The docking station of claim 1 further comprising a remote control interface by which the user selects the activity to be performed.

3. The docking station of claim 1 further comprising a media recorder that performs the user-selected activity, said media recorder is communicatively coupled to the control logic, and said media recorder is adapted to receive a media input signal to be digitally recorded and stored in said docking station.

4. The docking station of claim 3 wherein said media input signal comprises a video signal.

5. The docking station of claim 3 wherein said media input signal comprises an audio signal.

6. The docking station of claim 1 further comprising storage coupled to the control logic in which at least one user-selected, pre-programmed activity can be stored and wherein said control logic can execute at least one of said pre-programmed activities.

7. The docking station of claim 6 wherein the pre-programmed activity can be stored into the storage by the portable electronics device.

8. The docking station of claim 6 wherein the pre-programmed activity can be stored into the storage by a wireless control device.

9. The docking station of claim 1 wherein said control logic comprises a central processing unit.

10. The docking station of claim 1 further comprising an operating system executable by said control logic, said operating system being separate from an operating system contained in a portable electronics device that is adapted to mate to the docking station.

11. The docking station of claim 1 wherein, during initialization of said docking station, said control logic determines whether a portable electronics device is mated to the docking station.

12. The docking station of claim 11 wherein if no portable electronics device is mated to the docking station, the control logic performs, if present, a user-selected activity previously stored in said docking station.

13. The docking station of claim 11 wherein, if the control logic determines that a portable electronics device is mated to the docking station, control is transferred to the portable electronics device to control devices contained in the docking station.

14. The docking station of claim 11 wherein the user selects whether the portable electronics device is to control a device in the docking station or whether the portable electronics device is blocked from controlling the device in the docking station.

15. The docking station of claim 1 wherein said control logic determines whether a portable electronics device is mated to the docking station and, if so, a user is provided with a plurality of selectable options.

16. The docking station of claim 15 wherein the selectable options include:
precluding the docking station from performing the user-selected activity and permitting the docking station to perform the user-selected activity.

17. A system, comprising:
a docking station to which a portable electronics device is adapted to dock, said docking station contains a central processing unit (“CPU”) communicatively coupled to an operational device and a remote control interface and, regardless of whether the portable electronics device is docked to the docking station, said operational device can be controlled via signals received by the remote control interface from a remote control.

18. The system of claim 17 wherein said operational device comprises a media recorder that can receive and store a media signal.

19. The system of claim 17 wherein the docking station can receive and store a media signal without the portable electronics device docked to the docking station.

20. The system of claim 17 wherein the docking station is programmed by the portable electronics device with an activity to be performed and the activity is performed by the docking station when the portable electronics device is not docked.

21. The system of claim 13 wherein, upon docking the portable electronics device to the docking station, a user of the docking station is provided a selectable option whether the portable electronics device is to control the operational device or the docking station is to control the operational device.

22. A method, comprising:
if a portable electronics device is docked to a docking station, the docking station transitioning control to the portable electronics device; and
if a portable electronics device is not docked to the docking station, the docking station performing an activity pre-programmed in the docking station.

23. The method of claim 22 wherein if a portable electronics device is docked also quiescing a processor and operating system in the docking station.

24. The method of claim 22 further comprising the docking station determining whether a portable electronics device is docked thereto.

25. The method of claim 24 further comprising initializing the docking station and wherein determining whether a portable electronics device is docked is performed while initializing the docking station.

26. The method of claim 22 further comprising the portable electronics device storing at least one pre-programmed activity in said docking station to be performed by the docking station while the portable electronics device is not docked to the docking station.

27. The method of claim 18 wherein, while the docking station is performing said activity and a portable electronics device is docked with the docking station, the docking station provides a user with a plurality of options comprising permitting the docking station to continue performing the activity, terminating performance of the activity by the docking station, and permitting the docking station to continue performing the activity while transitioning control to the portable electronics device.

28. A method, comprising:
storing a pre-programmed activity in a docking station; and
the docking station performing the pre-programmed activity without a portable computer docked thereto.

29. The method of claim 28 wherein the pre-programmed activity comprises at least one activity selected from a group consisting of video recording, audio recording, video playback, and audio playback.

30. The method of claim 28 further comprising operating the docking station using a wireless remote control.

31. The method of claim 28 further comprising docking the portable computer to the docking station and then enabling a user to choose whether the portable computer or the docking station is to be in control.

32. The method of claim 31 further comprising quiescing an operating system in the docking station if the user chooses the portable computer to be in control.
